(19) United States
(12) Patent Application Publication
(10) Pub. No.: US 2002/0134498 A1
(43) Pub. Date: Sep. 26, 2002

(54) Method and apparatus for dating and storing perishable food

(76) Inventors: Russell P. Pennino, Placentia, CA (US); Michael C. Pennino, Orange, CA (US)

Correspondence Address: Joseph C. Andras, Myers, Dawes & Andras, Suite 1150, 19900 MacArthur Boulevard, Irvine, CA, 92612, US

(21) Appl. No.: 09/813,488

(22) Filed: Mar. 21, 2001

(51) Int. Cl. B41M 1/00

(52) U.S. Cl. 156/277; 156/350; 156/387

(57) ABSTRACT

Disclosed is a food labeling apparatus that contains a power supply, a supply of printable media, a clock, a controller, and a single-action actuator that, upon activation by a user, immediately produced a dated label for application to a food container and subsequent storage. The method of storing perishable food with the labeling apparatus includes the steps of maintaining information regarding a current date, and in response to only a single action being performed, printing a dated label bearing indication that is indicative of the current date. The preferred single-action actuator is a momentary contact, normally-open switch.

### FIELD OF THE INVENTION

The present invention relates generally to storing food and, more particularly, to a method and apparatus for dating and storing perishable food.

### BACKGROUND OF THE RELATED ART

FIG. 1 is a fanciful depiction of a food item 200 being stored in a food container 205 and then stored in a refrigerator 220. The food item 200 is intended to represent all variety of food items, not just leftovers. The food container 205 is shown as a plastic storage container, but food containers relevant to this invention include all variety of containers such as the original retail packaging, boxes, cartons, plastic bags, plastic wrap, foil, bottles, jars, Tupperware™, Corningware™, and so on. The refrigerator 220 is intended to represent any suitable storage arrangement including refrigerated storage, frozen storage, and dry storage (e.g. a pantry or a wine cellar).

FIG. 2 is a fanciful depiction of leftovers 200 first having been placed into a food container 205 consisting of a plastic bowl 211 and then sealed with a lid 212. As is often the case in restaurants and homes alike, conspicuously missing from the food container 205 is any indication of the date of storage.

The safe and cost efficient storage of perishable foot items is a problem for consumers and business owners. The problem arises from the fact that it takes too much effort to date the perishable food items before they are stored so that later, when the item is being considered for use, an informed decision can be made as to its freshness and suitability for use or its qualification for disposal.

Some restaurant operators, for example, try to date perishable food items by hand-writing the date of storage onto an adhesive label peeled from a supply of blank labels. That approach, however, is fraught with difficulty in that it takes some degree of effort and is subject to human error and human oversight. Some employees, in other words, are apt to omit this labeling step because of the time and effort involved. In addition, it is sometimes difficult to read a particular person's writing.

Consumers are even more likely to store perishable food items in a haphazard manner—applying the time tested “smell test” at a later date rather than relying on any date information. Some consumers endeavor to manually label their perishable food items, using an indelible pen, for example. Consistently labeling of this nature is hit and miss at best. Moreover, while a plastic bag may be written on directly, it is not practical to write on a regular dishes, pots and pans, or washable and re-usable food containers like those made by Tupperware™.

The problem applies to all varieties of food items contained in all variety of food containers. Examples of perishable food items that are amenable to labeling include: packaged meat (beef, poultry, and fish); fresh and purchased juices; home cooked food and leftovers that are stored for later use in the freezer or in the refrigerator in their original containers or in plastic bags, plastic containers, or the like; previously frozen items that have been thawed and must be used within a reasonable period of time; and so on and so forth.

Some food items do come with a “use by” or “open by” date, but that is often not the case and, even when that date it provided, it is often not useful for providing date information because the food item (e.g. milk) is used as an ingredient in another dish that is then stored in a new food container.

Prior inventors have developed systems related to storing perishable food items. For example, in U.S. Pat. No. 5,487,276 entitled “FOOD INVENTORY SYSTEM”, the inventors Namisniak et al. disclose a method and device that is directed to tracking the “eat by” date of multiple food items using a multi-line device with multiple countdown counters. The Namisniak et al. device is perhaps overly complicated for the task at hand.

General purpose labeling machines certainly exist, but they require a great deal of effort to operate and are unlikely to be used. In other words, it is impractical to expect somebody who is right then and there ready to store a perishable food item to take the time and effort to type in the date and time by successively pressing a series of alphanumeric buttons and then press yet another button to print the label, all while holding the food item that is to be stored. The user could, of course, put the food item down and go through the tedious process of preparing a label on a general purpose labeling machine, but as with the “manual” labeling approaches described above, the time and effort requirements of this approach make it likely that the label with never be made.

Even if one were determined enough to apply a conventional, tediously prepared label from a currently available labeling machine, there is also the problem of later removing that label from the food container.

There remains a need, therefore, for method and apparatus for dating and storing perishable food that addresses and resolves the above-described problems.

### SUMMARY OF THE INVENTION

In a first aspect, the invention resides in a food container labeling apparatus adapted for producing a dated label that is applied to a food container, comprising: a power supply; a supply of printable media; a printing means connected to the power supply for printing indicia on the printable media; a clock means for providing a current date; a single-action actuator that, in response to performance of only a single action, generates an actuator control signal; and a controller for producing a dated label in response to the actuator control signal by causing the printing means to print the current date on the printable media.

In a second aspect, the invention resides in a food container labeling apparatus adapted for producing a dated label that is applied to a food container, comprising: a power supply; a supply of printable media that is water soluble; a printing means connected to the power supply for printing indicia on the printable media; a clock means for providing a current date; a button and an associated momentary contact switch for immediately generating an actuator control signal in response to a single-action actuation of the button; and a controller for producing a dated label in response to the actuator control signal by causing the printing means to print the current date on the printable media, whereby dated label communicates a date associated with the food container and dissolves away when the food container is washed.

In a third aspect, the invention resides in a method of printing a dated label for storing perishable food comprising the steps of: maintaining information regarding a current date; and in response to only a single action being performed printing a dated label bearing indicia that is indicative of the current date, whereby the dated label is printed without a user having to know the current date and without having to type in indicia a that is indicative of the current date.

In a fourth aspect, the invention resides in a method of storing perishable food comprising the steps of: providing a food storage container; single-handedly and substantially-immediately actuating a label printing apparatus to produce a dated label; single-handedly grasping the dated label; applying the dated label to the food storage container; and storing the food storage container with the dated label for later consideration for use based on the dated label.

### BRIEF DESCRIPTION OF THE DRAWINGS

The just summarized invention can be best understood with reference to the following description taken in view of the drawings of which:

FIG. 1 is a fanciful diagram illustrating how a perishable food item (a leftover sandwich in this case) is placed into a food container (a plastic bowl in this case) and then stored (in a refrigerator in this case);

FIG. 2 is a diagram showing how perishable food is typically placed into a food container and then sealed for storage without any date;

FIG. 3 is block diagram of a first preferred apparatus according to this invention;

FIGS. 4A, 4B, and 4c are depictions of dated labels created by the apparatus of FIG. 1;

FIG. 5 is a perspective view of a container bearing a dated label as produced by the apparatus of FIG. 3;

FIGS. 6A, 6B, 6C, and 6D are a series of perspective views showing how a user may conveniently push a single-action actuator to produce a dated label, grasp the dated label, apply the dated label to the container, and then store the container with dated label in a refrigerator;

FIGS. 7A, 7B, 7C, and 7D are a series of close-up perspective views corresponding to FIGS. 6A, 6B, 6C, and 6D, showing more clearly the steps of push-grasp-apply-and-store;

FIG. 8 is a perspective view of the first preferred labeling apparatus of FIG. 3;

FIG. 9 is a perspective view of the labeling apparatus of FIG. 8 with the hinged door open and the battery cover removed;

FIG. 10 is an exploded perspective view of the labeling apparatus of FIG. 8 with its hinged door open and its ribbon cartridge removed, and with its battery cover open and its batteries removed;

FIG. 11 is a rear perspective view of the labeling apparatus of FIG. 8;

FIG. 12 is a rear, partially exploded perspective view of the apparatus of FIG. 8 with its hinged door open;

FIGS. 13A, 13B and 13C are perspective views of the preferred single-action actuator 70 and two alternative actuators 170 and 270;

FIGS. 14A, 14B, 14C and 14D are perspective views of various embodiments of the apparatus including a preferred embodiment 10 that is magnetically secured to a refrigerator, a built-in embodiment 110 that is integrated into the refrigerator, a counter-top embodiment 210, and a plug-in embodiment 310.

### DETAILED DESCRIPTION OF THE PREFERRED EMBODIMENT

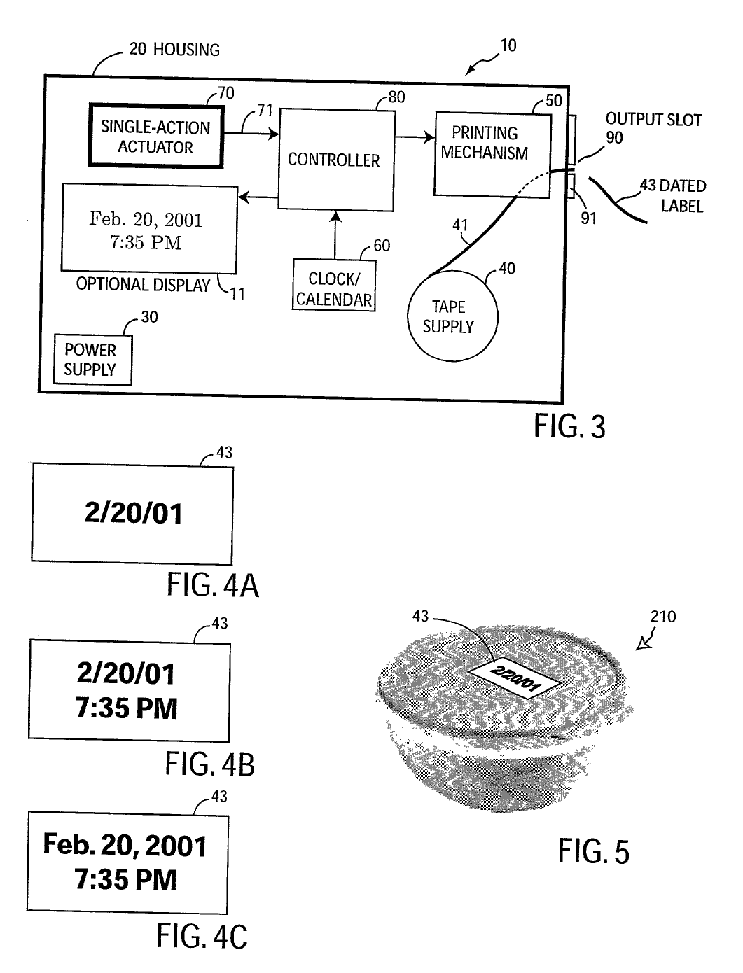

FIG. 3 is block diagram of a first preferred food container labeling apparatus 10 according to this invention. The preferred labeling apparatus 10, and methods of use related thereto, uniquely enable a single-action generation of a dated label 43 in a quick and efficient, nearly effortless manner that makes it more likely that users will consistently label food containers that hold perishable food items.

Many embodiments are possible. As shown in FIG. 3, however, the preferred apparatus generally comprises a housing 20 that contains a power supply 30, a supply of printable media 40 (e.g. a continuous supply of labels provided in a rolled tape format), a means 50 for printing indicia on the printable media 40, a means 60 for providing a current date (and perhaps time) (e.g. a so-called clock/calendar), a single-action actuator 70 that, in response to performance of only a single action, generates an actuator control signal 71, and a controller 80 for producing a dated label 43 in response to the actuator control signal 71 by causing the printing means 50 to print the current date provided by the clock means 60 onto the printable media 40 and, thereby, producing a dated label 43 from an output slot 90.

FIGS. 4A, 4B and 4C depict representative date and time indicia that may be printed on a dated label 43 produced in accordance with this invention. As shown, the dated label 43 may contain just the date, or it may contain the date and time. The exact format is not critical, those shown being but three examples. It is possible to automatically print other indicia along with the date and/or time, but it is important to not require any significant effort on the part of the user during use of the apparatus 10.

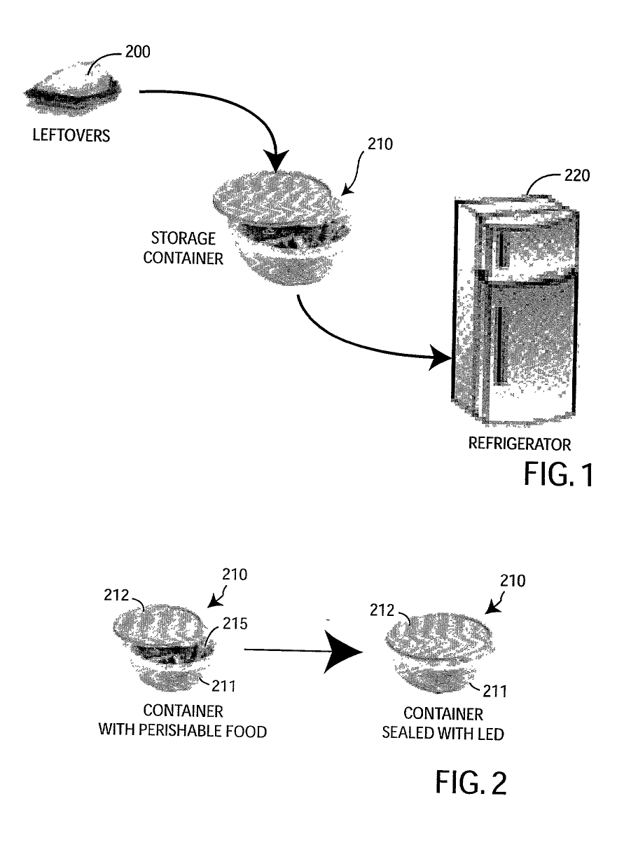

FIG. 5 depicts a food storage container 205 that is like those shown in FIGS. 1 and 2, but it now carries a dated label 43 that was conveniently and quickly produced in accordance with the apparatus and method of this invention. As a result, the food storage container 205 may now be safely stored for later consideration as to safe and timely use.

Further details as to the construction and operation of the preferred food labeling apparatus 10 may be considered by returning to FIG. 3.

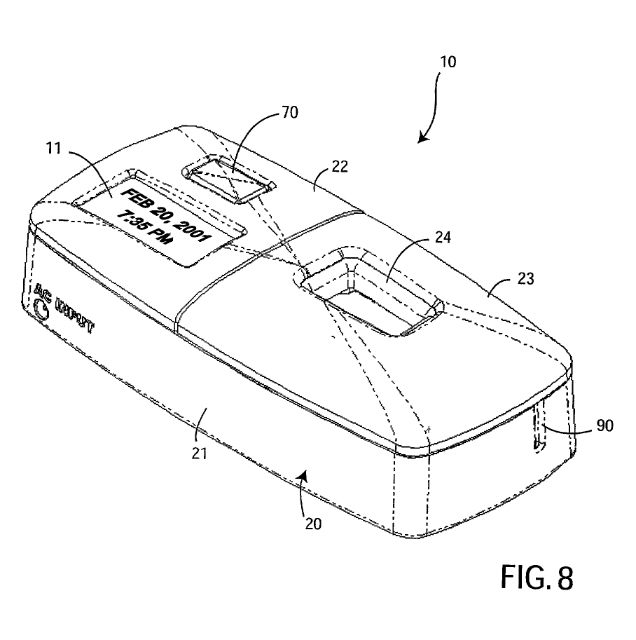

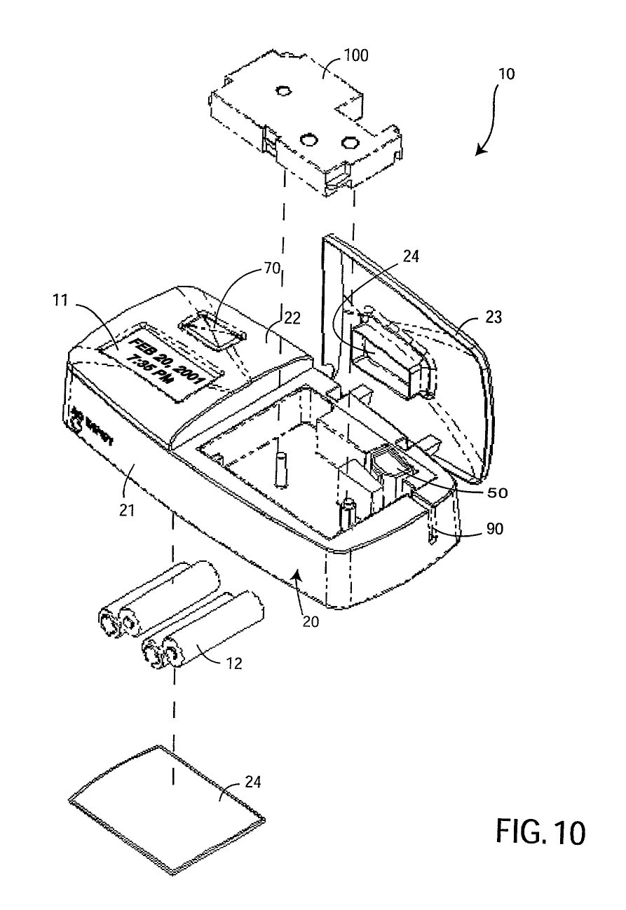

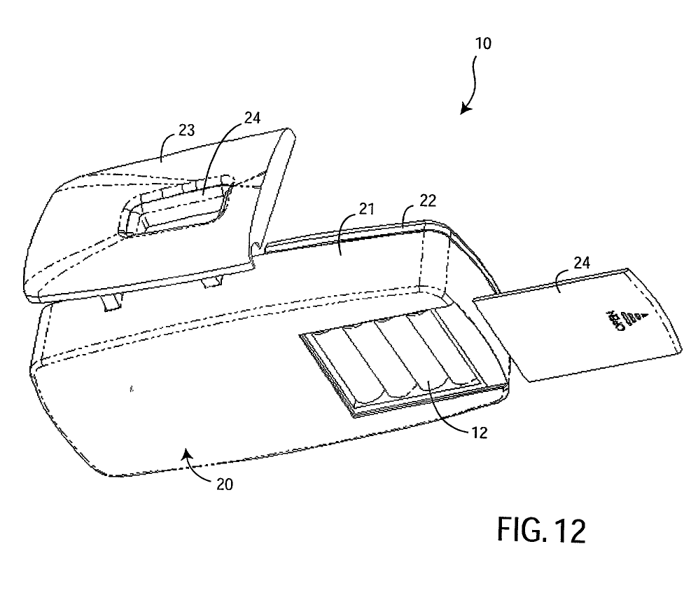

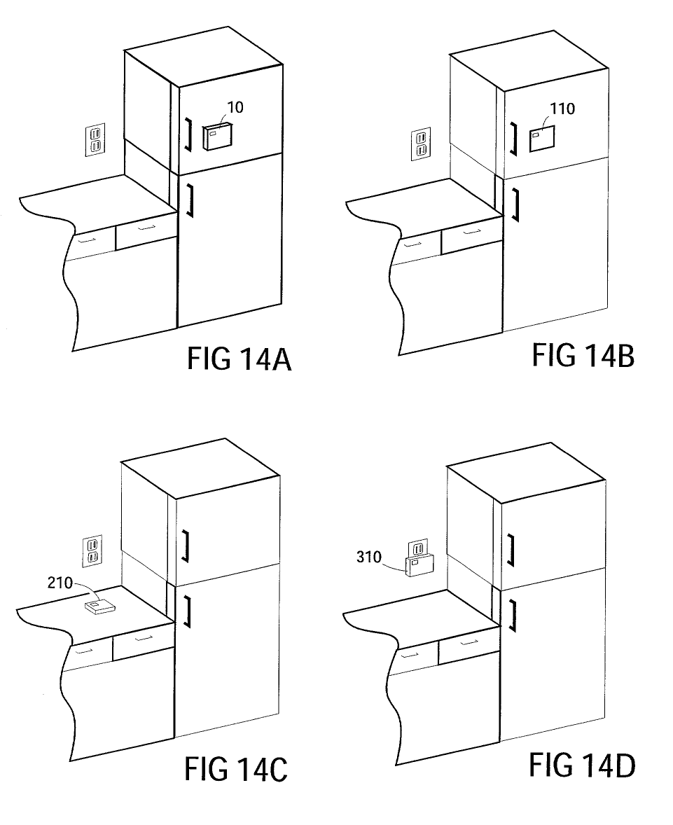

The power supply 30 may be of any suitable design including one or more batteries 12 (ee FIGS. 10 and 12) or direct AC power from a conventional outlet (See FIG. 14D). It is also possible, of course, to provide power via a remote transformer that connects to the apparatus 10 via a suitable jack (See FIG. 8 and the input jack labeled “AC Input”). Where batteries are used, the type of battery is immaterial. The batteries 12, for example, may be rechargeable batteries of nickel cadmium construction or nickel metal hydride construction or single use batteries of alkaline construction.

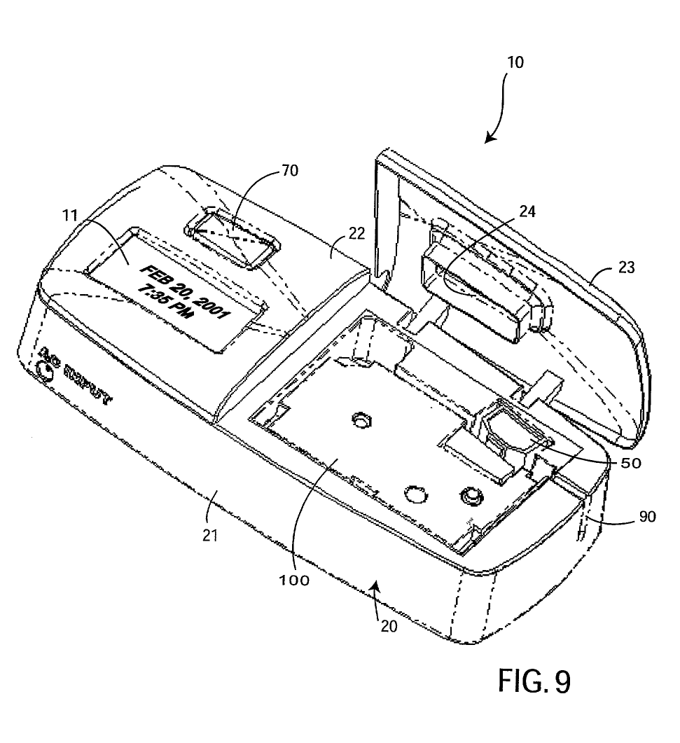

The printable media 40 is preferably provided in the form of a continuous ribbon of label material 41 contained, for example, in a cartridge 100 (See FIGS. 9 and 10) for easy replacement. The dated label 43 may be cut from the label material 41 without any leftover substrate or the dated label may be peeled away from a substrate (that may or may not remain in the apparatus 10). In either case, the dated label 43 should be ready for immediate application to the food container 205. The label material should have a peel-off adhesive so that it is easily removed from the food container or, alternatively, be fabricated from water soluble materials so that the dated label 43 will dissolve while the food container is held under running water or is being washed in the dishwasher.

The preferred means for printing comprises a printing mechanism 50 of any desired construction that is suitable for use with the chosen media 40. The precise construction of the printing mechanism does not form a part of this invention as the implementation details of such mechanism are well known or readily ascertained by those of ordinary skill in the art. The printing means 50, in fact, should be regarded as including printing mechanisms of yet to be invented construction because it is only necessary that the printing mechanism respond to the controller 80 (discussed above and in more detail below) by printing the appropriate indicia onto the printable media 41 in order to create the dated label 43.

The clock means 60 for providing a current date preferably consists of an ordinary clock/calendar that outputs a digital representation of a date and/or time. The clock means 60 may be powered by the power supply 30 or, given its relatively low power usage relative to that of the print mechanism 50, it may have its own separate power supply in order to reduce the probability of it having to be reset. The time, as opposed to the date, may be regarded as optional, but it is likely that consumers will find the clock useful if displayed for ready observation.

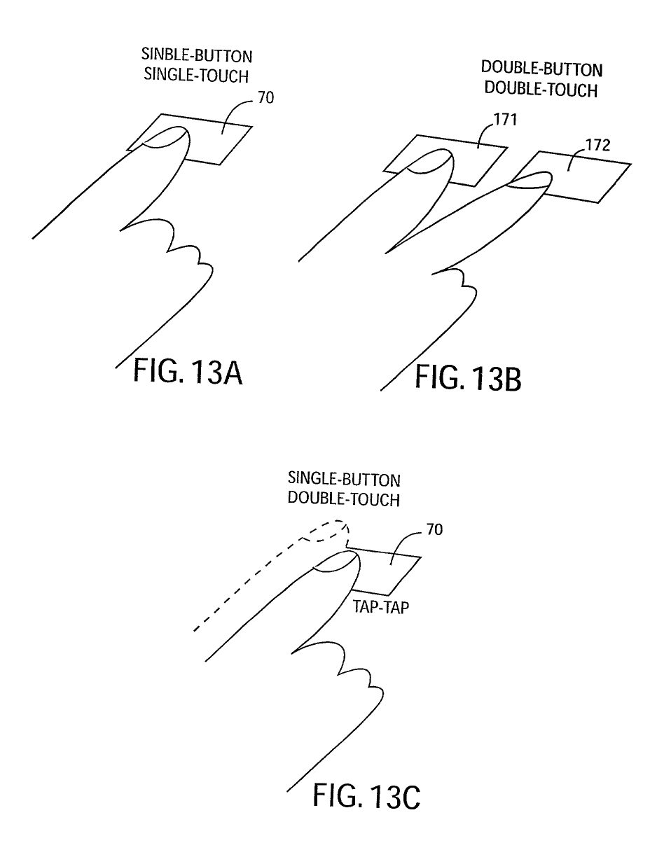

The single-action actuator 70, as noted above, generates an actuator control signal 71 in response to performance of only a single action. One push of the button will substantially immediately dispense a dated label 43 that can then be applied to any desired food container. In the preferred embodiment of the food labeling apparatus 10, the single-action actuator 70 comprises a single button in the form of a momentary contact, normally-open switch. As suggested by FIGS. 13A, 13B, and 13C, however, many different varieties of single-action actuators are possible. FIG. 13A shows the single-action actuator 70 in the form a a single-button single-touch switch 70 like that shown in FIG. 3. FIGS. 13B and 13C, however, depict two alternative embodiments. FIG. 13A shows a single-action actuator 170 consisting of two buttons 171 and 172 that must be simultaneously depressed . FIG. 13C shows a single-action actuator 270 with a single button that must be tapped twice in rapid succession. Many other varieties of single-action actuators, of course, may be used in accordance with the teaching of this invention. For example, the labeling apparatus 10 could be nearly hands-free by including suitable circuitry for responding to a spoken sound such as “print label”.

The controller 80, as shown, receives date and/or time information provided by the clock/calendar 60 and the actuator control signal 71 provided by the single-action actuator 70. In operation, and in response to user's actuation of the single-action actuator 70 and the resulting actuator control signal 71, the controller 80 communicates with the printing mechanism 50 and commands it to print indicia corresponding to the date and/or time onto the dated label 43. The controller 80 also communicates with a display 11 (discussed below) in order to present the user with the current date for setting and/or confirmation purposes. The preferred controller is a microcontroller with sufficient ROM and RAM as required, but any suitable control electronics may suffice such as, but not limited to, various programmable logic devices.

As also shown in FIG. 3, the preferred apparatus 10 further comprises an optional display 11 that may be used for inputting or adjusting the date and time and for later confirming the date and time is correct. The intended display 11 is an LCD display, but if a display is included, any suitable display may be used.

Where the printable media 40 comprises a continuous ribbon of label material 41, as presently preferred, the output slot 90 may also contain means 91 for separating the dated label 43 from the continuous ribbon of label material. Suitable separating means 91 include an electromechanical cutting mechanism (automatic) or a serrated tear bar (manual). Other approaches are possible.

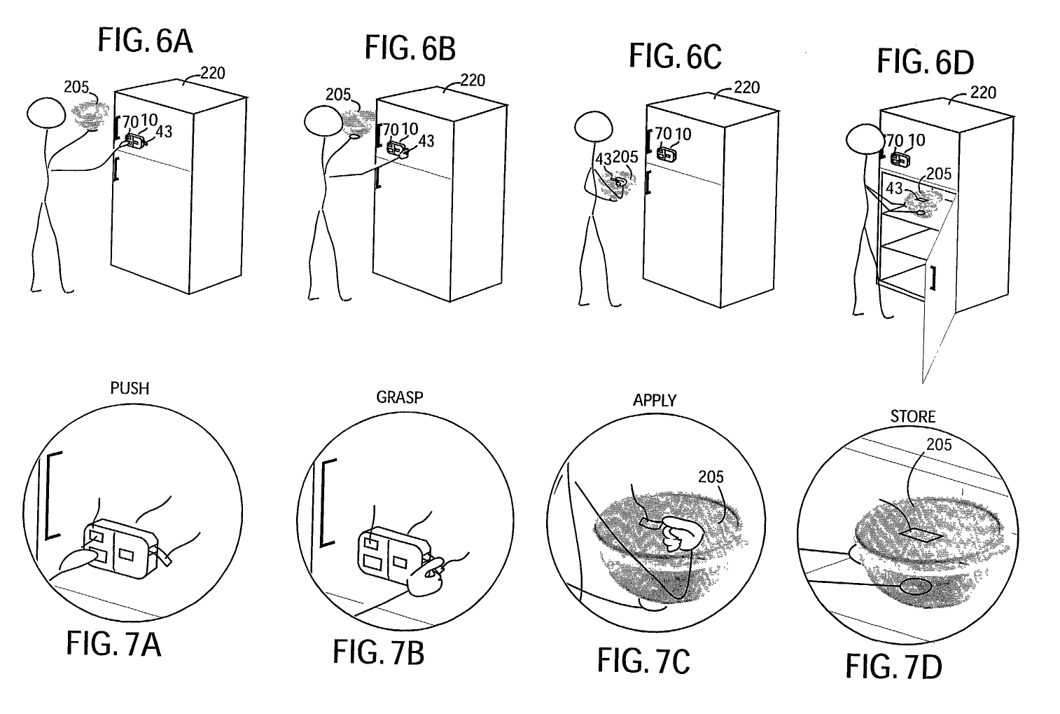

FIGS. 6A, 6B, 6C and 6D, and corresponding closeup FIGS. 7A, 7B, 7C and 76D, are a parallel series of perspective views showing a method of storing perishable food that is enabled by the food labeling apparatus 10 of this invention. The method, in shorthand, uniquely and conveniently consists of “push”, “grasp”, “apply” and “store”. Significantly, the method is so convenient that users are likely to actually label the food items in a continuous and consistent manner. The result is more efficient and safe use of food items. In other words, by having a dated label 43 on the food container 205, it will be easy to later decide whether to eat the leftovers or throw them away.

FIGS. 6A and 7A show how a user may conveniently push the single-action actuator 70 to produce a dated label 43. Significantly, due to the single-action actuator 70, the user may be holding a food container 205 in one hand and activate the single-action actuator 70 with his free hand.

FIGS. 6B and 7B show how a user may then grasp the dated label 43, again all while holding a food container 205. The dated label 43 may emerge pre-separated, may be cut using an automatic electromechanical separator 91, or may require the user to pull the dated label 43 along a serrated edge 91 as a continuation of the grasping step.

FIGS. 6C and 7C show how the user may apply the dated label 43 to the container 205, again with the user's free hand.

FIGS. 6D and 7D, finally, show how the user may store the container 205 with dated label 43 in a refrigerator 220. The method, again, is uniquely as convenient as push, grasp, apply and store.

FIGS. 8, 9, 10, 11 and 12 are various views of the internal and external details of a presently preferred food labeling apparatus 10 according to this invention. As shown, the preferred food labeling apparatus 10 is relatively small in size and generally comprises a housing 20 that contains the functional blocks discussed above and depicted in FIG. 3. Because the preferred apparatus 10 is small in size, and because it contains the single-action actuator 70 discussed above, a person can hold a food container in one hand while printing a dated label with the other. It may be convenient, however, to place or mount the apparatus in certain convenient location as depicted in FIGS. 14A-14C discussed below.

As shown in FIG. 8, the housing 20 includes a side wall portion 21, a fixed upper portion 22, and a hinged door portion 23. The single-action actuator 70 is present at the upper left of the fixed upper portion 22. The display 11 is immediately below the actuator 70. The output slot 90 is located in the housing's side wall 21. The hinged door portion 23 contains a window 24 to permit the user to see how much labeling media remains.

FIG. 9 shows the apparatus 10 of FIG. 8 with the hinged door portion 23 pivoted open, thereby revealing the preferred embodiment's use of a disposable cassette 100 similar to the cassettes already used in other general purpose labeling machines. The cassette 100 is preferably designed so that the label's backing will be peeled off and returned to the cassette 100, leaving the user with a sticky, ready-to-use label. The printing mechanism 50 is visible adjacent to the cassette 100, next to the output slot 90.

FIG. 10 is an exploded view of the labeling apparatus 10 with the cassette 100 floating above the advance mechanism (not numbered), and with a plurality of batteries 12 and a suitable battery compartment cover 24 floating below the overall apparatus.

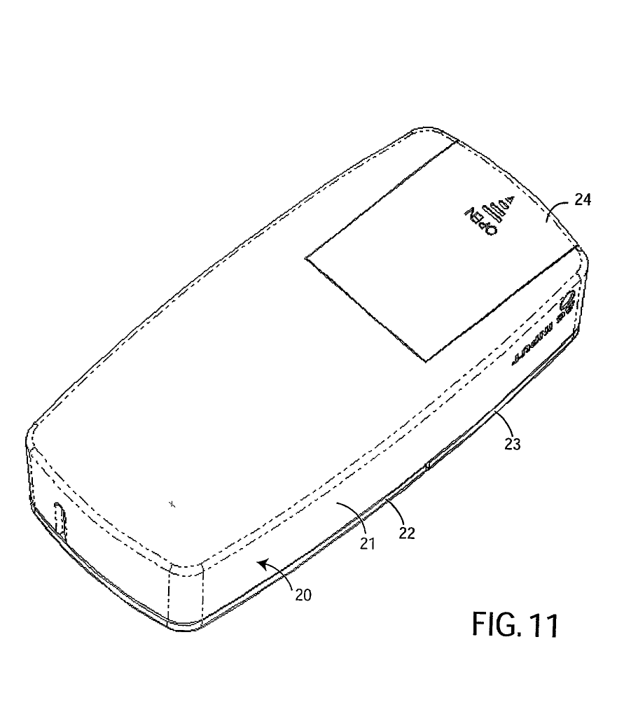

FIG. 11 is a perspective view of the rear of the labeling apparatus with the battery compartment cover 24 in place and FIG. 12 is a rear perspective view with the hinged door portion 23 opened and with the battery compartment cover slid to the right to expose the batteries 12.

The preferred labeling apparatus 10 depicted by FIGS. 8-12 is but one design. The overall appearance and the location of and specific type and construction of its constituent elements may be varied without departing from the scope and spirit of the below appended claims. For example, the labeling apparatus 10 could be designed to incorporate decorative faceplates that come in different colors or themes. In addition, an industrial version more suitable for commercial restaurant use could be constructed with more regard to durability than to aesthetics.

FIGS. 14A, 14B, 14C and 14D depict various further embodiments of a food labeling apparatus according to this invention.

FIG. 14A, in particular, shows the first preferred labeling apparatus 10 secured to refrigerator by a suitable means. Examples includes adhesive tape or magnetic strips.

FIG. 14B shows a second embodiment of a labeling apparatus 110 incorporated into the refrigerator itself.

FIG. 14C shows a third labeling apparatus 210 that resides on the surface of a countertop and that is evidently battery powered. The labeling apparatus 210 may actually be the same apparatus 10 that is secured to the refrigerator, it being the user's option where to mount it.

FIG. 14D, lastly, depicts an embodiment 310 that plugs directly into an AC outlet so that it resides above the countertop and so that batteries are not needed. It would be desirable, in this context, to provide the apparatus 310 with a suitable “swing-out” plug so that the device is mounted as shown as an option.

The above description is of a preferred embodiment of the invention, the scope of which should not be limited thereby but rather should be interpreted in light of the scope and spirit of following claims.

We claim:

1. A food container labeling apparatus adapted for producing a dated label that is applied to a food container, comprising:
a power supply;
a supply of printable media;
a printing means connected to the power supply for printing indicia on the printable media;
a clock means for providing a current date;
a single-action actuator that, in response to performance of only a single action, generates an actuator control signal; and
a controller for producing a dated label in response to the actuator control signal by causing the printing means to print the current date on the printable media.

2. The food container labeling apparatus of claim 1 wherein the single-action actuator comprises a button.

3. The food container labeling apparatus of claim 2 wherein the single-action involves a single touch of the button.

4. The food container labeling apparatus of claim 2 wherein the single-action involves touching the button at least two times in succession.

5. The food container labeling apparatus of claim 1 wherein the single-action actuator comprises a pair of side-by-side buttons and wherein the single-action involves the simultaneous touching of both side-by-side buttons.

6. The food container labeling apparatus of claim 2 wherein the button is a momentary contact, normally-open switch.

7. The food container labeling apparatus of claim 1 wherein the single-action actuator comprises a touch plate-activated switch.

8. The food container labeling apparatus of claim 1 wherein the printable media dissolves in water whereby the dated label produced therefrom dissolves away when the food container is washed.

9. The food container labeling apparatus of claim 1 wherein the supply of printable media comprises a roll of printable media.

10. The food container labeling apparatus of claim 9 wherein the roll of printable media is continuous ribbon of label material.

11. The food container-labeling apparatus of claim 10 wherein the roll of pintable media is contained in a replaceable cartridge.

12. The food container labeling apparatus of claim 10 further comprising a means for separating the dated label from the continuous ribbon of label material.

13. The food container labeling apparatus of claim 12 wherein the separating means comprises a serrated tear bar.

14. The food container labeling apparatus of claim 13 wherein the separating means comprises an electromechanical cutting mechanism.

15. The food container labeling apparatus of claim 1 wherein the clock means provides a current date and a current time and wherein the controller causes the printing means to print the current date and the current time on the printable media in response to the actuator control signal.

16. The food container labeling apparatus of claim 1 built into a door of a refrigerator.

17. The food container labeling apparatus of claim 1 further comprising means for securing the apparatus to a refrigerator.

18. The food container labeling apparatus of claim 17 wherein the securing means is a magnet.

19. The food container labeling apparatus of claim 17 wherein the securing means is an adhesive pad.

20. The food container labeling apparatus of claim 1 wherein the power supply is a battery.

21. The food container labeling apparatus of claim 20 wherein the power supply comprises a voltage regulator connected to an AC outlet.

22. The food container labeling apparatus of claim 21 further comprising outlet prongs on a backside of the apparatus for connection to an AC outlet.

23. The food container labeling apparatus of claim 22 wherein the outlet prongs pivot between a substantially-flush position and an extended position.

24. The food container labeling apparatus of claim 1 further comprising means for setting the clock means.

25. The food container labeling apparatus of claim 24 wherein the single-action actuator comprises a first button and wherein the means for setting the clock means comprises a second button that is separate from the first button.

26. The food container labeling apparatus of claim 24 wherein the single-action actuator is actuated to produce a dated label through a momentary contact and wherein the means for setting the clock means comprises:
the single-action actuator; and
means for determining that the single-action actuator has been actuated for period of time greater than the momentary, contact that results in a dated label.

27. The food container labeling apparatus of claim 1 further comprising a display for visually communicating the current date.

28. A food container labeling apparatus adapted for producing a dated label that is applied to a food container, comprising:
a power supply;
a supply of printable media that is water soluble;
a printing means connected to the power supply for printing indicia on the printable media;
a clock means for providing a current date;
a button and an associated momentary contact switch for immediately generating an actuator control signal in response to a single-action actuation of the button; and
a controller for producing a dated label in response to the actuator control signal by causing the printing means to print the current date on the printable media,
whereby dated label communicates a date associated with the food container and dissolves away when the food container is washed.

29. A method of printing a dated label for storing perishable food comprising the steps of:
maintaining information regarding a current date; and
in response to only a single action being performed, printing a dated label bearing indicia that is indicative of the current date,
whereby the dated label is printed without a user having to know the current date and without having to type in indicia a that is indicative of the current date.

30. The method of claim 29 wherein the single action is depressing a button.

31. The method of claim 29 wherein the single action is speaking of a sound.

32. A method of storing perishable food comprising the steps of:
providing a food storage container;
singled-handedly and substantially-immediately actuating a label printing apparatus to produce a dated label;
single-handedly grasping the dated label;
applying the dated label to the food storage container; and
storing the food storage container with the dated label for later consideration for use based on the dated label.
